(19) United States
(12) Patent Application Publication
(10) Pub. No.: US 2025/0183698 A1
(43) Pub. Date: Jun. 5, 2025

(54) Energy Management Method For Solar Freezer Truck

(71) Applicant: The Hong Kong Polytechnic University, Hong Kong (CN)

(72) Inventors: Ka Wai Eric Cheng, Hong Kong (CN); Xiangdang Xue, Hong Kong (CN)

(73) Assignee: The Hong Kong Polytechnic University, Hong Kong (CN)

(21) Appl. No.: 18/970,108

(22) Filed: Dec. 5, 2024

Related U.S. Application Data
(60) Provisional application No. 63/606,144, filed on Dec. 5, 2023.

(51) Int. Cl. H02J 7/35; B60H 1/00; H02J 7/00; H02J 7/14; H02J 7/34

(52) U.S. Cl. CPC H02J 7/35; B60H 1/00428; B60H 1/0075; H02J 7/0048; H02J 7/00712; H02J 7/1423; H02J 7/1438; H02J 7/342; H02J 2207/20; H02J 2310/46

(57) ABSTRACT

Disclosed in the present application is an energy management method for solar freezer trucks, the solar freezer truck includes a photo-voltaic (PV) module, a first battery, a freezer compressor, an engine generator, and an external power adapter connected by an energy management unit, and the energy management method includes obtaining an output power of the PV module; and switching, by the energy management unit, power paths to the freezer compressor according to the output power of the PV module.

### CROSS REFERENCE

The present application claims benefit of U.S. provisional application No. 63/606,144, filed on Dec. 5, 2023, and the entire contents thereof are incorporated herein by reference.

### TECHNICAL FIELD

The present disclosure relates to an energy management method, more particularly relates to an energy management method applied to a solar freezer truck.

### BACKGROUND

Refrigeration is a requirement to ensure the quality of agricultural, food and medical products, longevity, and safety. Since the transportation of agricultural, food and medical products often relies on temperature control, conventional transportation results in additional emissions because of the extra fuel requirements for cooling and because of leakage of fuel. Greenhouse gas emissions can be as high as 40% of automobile emissions due to the conventional use of diesel engine vapor compression refrigeration systems. While the goods are moving in and out, the engine is still on to support the freezer system. Consequently, the present freezer trucks are negatively impacting the environment both in terms of emissions, which contribute to the greenhouse effect, and noise. Clearly, the technology of conventional freezer trucks is outdated.

It should be noted that, information disclosed in the above background portion is provided only for better understanding of the background of the present disclosure, and thus it may contain information that does not form the prior art known by those ordinary skilled in the art.

### SUMMARY

The purpose of the present disclosure is to provide an energy management method applied to a solar freezer truck.

In a first aspect, an embodiment of the present disclosure provides an energy management method for solar freezer truck including a photo-voltaic (PV) module, a first battery, a freezer compressor, an engine generator, and an external power adapter connected by an energy management unit, the method includes:
obtaining an output power of the PV module; and
switching, by the energy management unit, power paths to the freezer compressor according to the output power of the PV module.

In some implementations, the solar freezer truck further includes a first charger configured to converting the output power of the PV module to a power on the power paths, and wherein the first charger is configured to always maximize the output power of the PV module if the PV module can output power.

In some implementations, the switching, by the energy management unit of the solar freezer truck, power paths to the freezer compressor according to the output power of the PV module includes:
in a case that the output power of the PV module is equal to or greater than an input power of the freezer compressor, switching to a first path from the PV module to the freezer compressor;
in a case that the output power of the PV module is smaller than the input power of the freezer compressor and the external power adapter has an external power input, switching to a second path from the external power adapter to the freezer compressor; and
in a case that the output power of the PV module is smaller than the input power of the freezer compressor and the external power adapter has no external power input, switching to a third path from the PV module and the first battery to the freezer compressor.

In some implementations, the first path further includes a first sub path to the first battery, and the method further includes:
in a case that a state of charge (SOC) of the first battery is less than a first SOC level and equal to or more than a second SOC level, turning on the first sub path to provide power from the PV module to the first battery;
in a case that the SOC of the first battery is less than the second SOC level, adding the external power adapter or the engine generator, whichever available, to the first sub path, to provide additional power to the first battery; and
in a case that the SOC of the first battery is more than the first SOC level, turning off the first sub path and supplying all power of the PV module to the freezer compressor.

In some implementations, the turning on the first sub path to provide power from the PV module to the first battery further includes:
in a case that the output power of the PV module is equal to the input power of the freezer compressor and the SOC of the first battery is less than the first SOC level, adding the external power adapter or the engine generator, whichever available, to the first sub path, to provide additional power to the first battery.

In some implementations, the second path further includes a second sub path to the first battery, and the method further includes:
in a case that a state of charge (SOC) of the first battery is less than a first SOC level and equal to or more than a second SOC level, turning on the second sub path to provide power from the PV module to the first battery;
in a case that the SOC of the first battery is less than the second SOC level, adding the external power adapter, to the second sub path, to provide additional power to the first battery; and
in a case that the SOC of the first battery is more than the first SOC level, turning off the second sub path and adding the PV module to the second path to provide additional power to the freezer compressor.

In some implementations, the external power adapter is an external energy storage source and the second path further includes a second sub path to the first battery, and wherein switching to the second path from the external power adapter to the freezer compressor includes:
in a case that a power of the external energy storage source is greater than the input power of the freezer compressor, turning on the second sub path to provide additional power to the first battery from the external energy storage source; and
in a case that the power of the energy storage source is smaller than the input power of the freezer compressor, turning on the second sub path to provide additional power to the freezer compressor from the first battery.

In some implementations, in a case that the input power of the freezer compressor is zero, the second sub path is turned on and the method further includes:
charging the first battery with the external energy storage source through the second sub path; or
charging the external energy storage source with the first battery through the second sub path when the external energy storage source requires to be charged and a SOC of the first battery is greater than a second SOC level.

In some implementations, the method further includes: in a case that the external power adapter has no external power input and an output power of the engine generator is greater than the input power of the freezer compressor, connecting the engine generator to the second path to replace the external power adapter.

In some implementations, the third path further includes a third sub path to the engine generator, and the method further includes:
in a case that a state of charge (SOC) of the first battery is less than a second SOC level, turning on the third sub path to provide additional power to the third path by the engine generator.

In some implementations, the method further includes: in a case that the additional power provided by the engine generator is greater than a difference between the input power of the freezer compressor and the output power of the PV module, stopping an output of the first battery and charging the first battery with the additional power provided by the engine generator in addition to providing the additional power to the freezer compressor.

In some implementations, the method further includes: in a case that the additional power provided by the engine generator is less than a difference between the input power of the freezer compressor and the output power of the PV module, warning that the first battery needs to be charged when the SOC of the first batter is draped to a third SOC level.

In some implementations, the solar freezer truck further includes a second battery connected to the engine generator, and wherein the additional power provided by the engine generator is provided to the third sub path through the second battery.

In a second aspect, an embodiment of the present disclosure provides a solar freezer truck, including a photo-voltaic (PV) module, a first battery, a freezer compressor, an engine generator, and an external power adapter connected by an energy management unit, wherein the energy management unit includes a circuit configured to:
switch power paths to the freezer compressor according to an output power of the PV module.

In some implementations, the solar freezer truck further includes a first charger configured to converting the output power of the PV module to a power on the power paths, and wherein the first charger is configured to always maximize the output power of the PV module if the PV module can output power.

In some implementations, the circuit is further configured to:
in a case that the output power of the PV module is equal to or greater than an input power of the freezer compressor, switch to a first path from the PV module to the freezer compressor;
in a case that the output power of the PV module is smaller than the input power of the freezer compressor and the external power adapter has an external power input, switch to a second path from the external power adapter to the freezer compressor; and
in a case that the output power of the PV module is smaller than the input power of the freezer compressor and the external power adapter has no external power input, switch to a third path from the PV module and the first battery to the freezer compressor.

In some implementations, the first path further includes a first sub path to the first battery, and the circuit is further configured to:
in a case that a state of charge (SOC) of the first battery is less than a first SOC level and equal to or more than a second SOC level, turn on the first sub path to provide power from the PV module to the first battery;
in a case that the SOC of the first battery is less than the second SOC level, add the external power adapter or the engine generator, whichever available, to the first sub path, to provide additional power to the first battery; and
in a case that the SOC of the first battery is more than the first SOC level, turn off the first sub path and supply all power of the PV module to the freezer compressor.

In some implementations, the circuit is further configured to: in a case that the output power of the PV module is equal to the input power of the freezer compressor and the SOC of the first battery is less than the first SOC level, adding the external power adapter or the engine generator, whichever available, to the first sub path, to provide additional power to the first battery.

In some implementations, the second path further includes a second sub path to the first battery, and the circuit is further configured to:
in a case that a state of charge (SOC) of the first battery is less than a first SOC level and equal to or more than a second SOC level, turn on the second sub path to provide power from the PV module to the first battery;
in a case that the SOC of the first battery is less than the second SOC level, add the external power adapter, to the second sub path, to provide additional power to the first battery; and
in a case that the SOC of the first battery is more than the first SOC level, turn off the second sub path and adding the PV module to the second path to provide additional power to the freezer compressor.

In some implementation, the external power adapter is an external energy storage source and the second path further includes a second sub path to the first battery, and the circuit is further configured to:
in a case that a power of the external energy storage source is greater than the input power of the freezer compressor, turn on the second sub path to provide additional power to the first battery from the external energy storage source; and
in a case that the power of the energy storage source is smaller than the input power of the freezer compressor, turn on the second sub path to provide additional power to the freezer compressor from the first battery.

In some implementations, in a case that the input power of the freezer compressor is zero, the second sub path is turned on and the circuit is further configured to:
charge the first battery with the external energy storage source through the second sub path; or
charge the external energy storage source with the first battery through the second sub path when the external energy storage source requires to be charged and a SOC of the first battery is greater than a second SOC level.

In some implementations, in a case that the external power adapter has no external power input and an output power of the engine generator is greater than the input power of the freezer compressor, the circuit is further configured to connect the engine generator to the second path to replace the external power adapter.

In some implementations, the third path further includes a third sub path to the engine generator, and the circuit is further configured to:
in a case that a state of charge (SOC) of the first battery is less than a second SOC level, turn on the third sub path to provide additional power to the third path by the engine generator.

In some implementations, in a case that the additional power provided by the engine generator is greater than a difference between the input power of the freezer compressor and the output power of the PV module, the circuit is further configured to stop an output of the first battery and charge the first battery with the additional power provided by the engine generator in addition to providing the additional power to the freezer compressor.

In some implementations, in a case that the additional power provided by the engine generator is less than a difference between the input power of the freezer compressor and the output power of the PV module, the circuit is further configured to warn that the first battery needs to be charged when the SOC of the first batter is draped to a third SOC level.

In some implementations, the solar freezer truck further includes a second battery connected to the engine generator, and wherein the additional power provided by the engine generator is provided to the third sub path through the second battery.

It is to be understood that both the foregoing general description and the following detailed description are exemplary and explanatory only and are not restrictive of the present disclosure.

### BRIEF DESCRIPTION OF THE DRAWINGS

In order to more clearly illustrate the technical solutions of the embodiments of the present disclosure, the drawings required for use in the embodiments will be briefly introduced below. It should be understood that the following drawings only show certain embodiments of the present disclosure and should not be regarded as limiting the scope.

FIG. 1A is a schematic diagram of a solar freezer truck according to an embodiment of the present disclosure;

FIG. 1B is a schematic diagram of a solar freezer truck according to an embodiment of the present disclosure;

FIG. 2 is flowchart of an energy management method for solar freezer truck according to an embodiment of the present disclosure;

FIG. 3A is schematic diagram of an energy management mode for solar freezer truck according to an embodiment of the present disclosure;

FIG. 3B is schematic diagram of an energy management mode for solar freezer truck according to an embodiment of the present disclosure;

FIG. 3C is schematic diagram of an energy management mode for solar freezer truck according to an embodiment of the present disclosure;

FIG. 3D is schematic diagram of an energy management mode for solar freezer truck according to an embodiment of the present disclosure;

FIG. 3E is schematic diagram of an energy management mode for solar freezer truck according to an embodiment of the present disclosure;

FIG. 4 is schematic diagram of an energy management mode for solar freezer truck according to an embodiment of the present disclosure;

FIG. 5 is schematic diagram of an energy management mode for solar freezer truck according to an embodiment of the present disclosure;

FIG. 6 is schematic diagram of an energy management mode for solar freezer truck according to an embodiment of the present disclosure;

FIG. 7 is schematic diagram of an energy management mode for solar freezer truck according to an embodiment of the present disclosure;

FIG. 8 is schematic diagram of an energy management mode for solar freezer truck according to an embodiment of the present disclosure;

FIG. 9 is schematic diagram of an energy management mode for solar freezer truck according to an embodiment of the present disclosure;

FIG. 10 is schematic diagram of an energy management mode for solar freezer truck according to an embodiment of the present disclosure;

FIG. 11 is schematic diagram of an energy management mode for solar freezer truck according to an embodiment of the present disclosure;

FIG. 12 is schematic diagram of an energy management mode for solar freezer truck according to an embodiment of the present disclosure;

FIG. 13 is schematic diagram of an energy management mode for solar freezer truck according to an embodiment of the present disclosure;

FIG. 14 is schematic diagram of an energy management mode for solar freezer truck according to an embodiment of the present disclosure;

FIG. 15 is schematic diagram of an energy management mode for solar freezer truck according to an embodiment of the present disclosure;

FIG. 16 is schematic diagram of an energy management mode for solar freezer truck according to an embodiment of the present disclosure;

FIG. 17 is schematic diagram of an energy management mode for solar freezer truck according to an embodiment of the present disclosure;

FIG. 18 is schematic diagram of an energy management mode for solar freezer truck according to an embodiment of the present disclosure;

FIG. 19 is schematic diagram of an energy management mode for solar freezer truck according to an embodiment of the present disclosure;

FIG. 20 is a schematic diagram of a solar freezer truck according to an embodiment of the present disclosure;

FIG. 21A is a schematic diagram of a solar freezer truck according to an embodiment of the present disclosure; and

FIG. 21B is a schematic diagram of a solar freezer truck according to an embodiment of the present disclosure.

### DETAILED DESCRIPTION

Hereinafter, the technical solutions in the embodiments of the present disclosure will be clearly and completely described in conjunction with the drawings in the embodiments of the present disclosure. Obviously, the described embodiments are only a part of the embodiments of the present disclosure, rather than all the embodiments. The components of the embodiments of the present disclosure generally described and shown in the drawings here can be arranged and designed in various different configurations. Therefore, the following detailed description of the embodiments of the present disclosure provided in the drawings is not intended to limit the scope of the claimed invention, but merely represents the selected embodiments of the present disclosure. Based on the embodiments of the present disclosure, all other embodiments obtained by those skilled in the art without making creative effort belong to the scope of protection of the present disclosure.

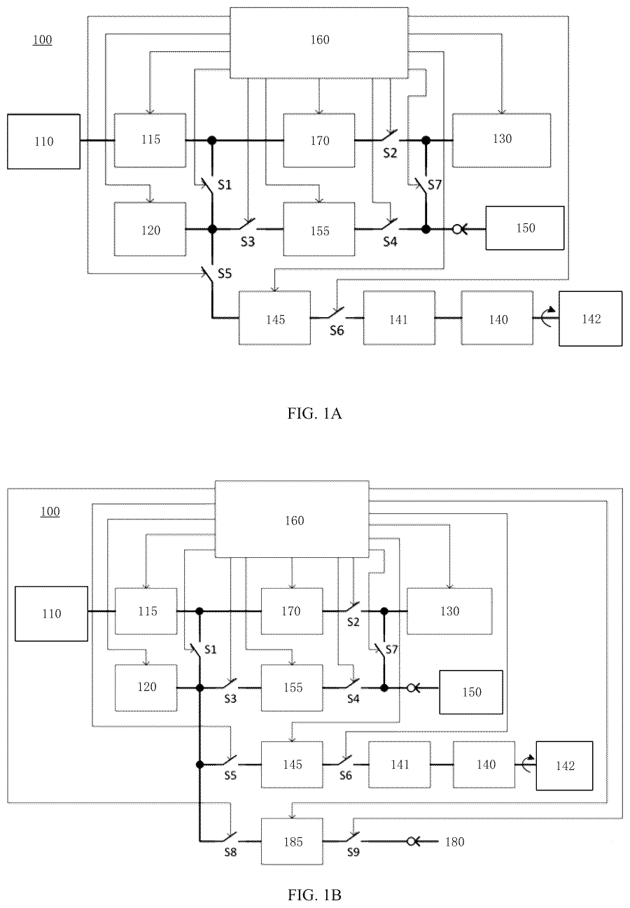

FIG. 1A is a schematic diagram of a solar freezer truck according to an embodiment of the present disclosure. As shown in FIG. 1A, the solar freezer truck 100 includes a photo-voltaic (PV) module 110, a first battery 120, a freezer compressor 130, an engine generator 140, and an external power adapter 150, which are connected by an energy management unit 160. In the present disclosure, the energy management unit 160 is configured to control the connection circuits amongst the above parts of the solar freezer truck 100, to switch power paths to the freezer compressor according to an output power of the PV module, which will be described in further detail hereinafter.

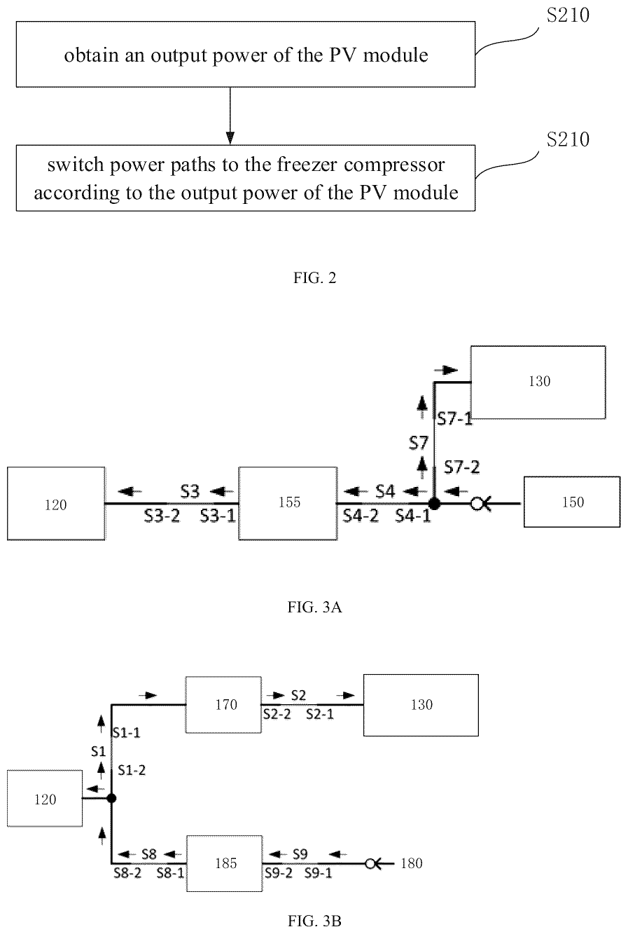

FIG. 2 is flowchart of an energy management method for solar freezer truck according to an embodiment of the present disclosure. As shown in FIG. 2, the method includes:
S210, obtain an output power of the PV module; and
S220, switch power paths to the freezer compressor according to the output power of the PV module.

According to the embodiment of the present disclosure, based on the output power of the PV module, the solar freezer truck 100 may switch different power paths to the freezer compressor, which enables to maximize the output power of the PV module, optimally distribute the output power of the PV module, the output power of the first battery, the output power of the engine generator and the output power of the offboard power supply, protect the first batter from the performance degradation, maintain the high-efficiency operation of the first batter, prolong the service lifetime of the first batter, improve the refrigeration performance of solar freezer trucks, and improve the operating efficiency of the energy management system.

In some implementations, the solar freezer truck further includes a first charger configured to converting the output power of the PV module to a power on the power paths, and wherein the first charger is configured to always maximize the output power of the PV module if the PV module can output power.

In some implementations, the switching, by the energy management unit of the solar freezer truck, power paths to the freezer compressor according to the output power of the PV module includes:
in a case that the output power of the PV module is equal to or greater than an input power of the freezer compressor, switching to a first path from the PV module to the freezer compressor;
in a case that the output power of the PV module is smaller than the input power of the freezer compressor and the external power adapter has an external power input, switching to a second path from the external power adapter to the freezer compressor; and
in a case that the output power of the PV module is smaller than the input power of the freezer compressor and the external power adapter has no external power input, switching to a third path from the PV module and the first battery to the freezer compressor.

In some implementations, the first path further includes a first sub path to the first battery, and the method further includes:
in a case that a state of charge (SOC) of the first battery is less than a first SOC level and equal to or more than a second SOC level, turning on the first sub path to provide power from the PV module to the first battery;
in a case that the SOC of the first battery is less than the second SOC level, adding the external power adapter or the engine generator, whichever available, to the first sub path, to provide additional power to the first battery; and
in a case that the SOC of the first battery is more than the first SOC level, turning off the first sub path and supplying all power of the PV module to the freezer compressor.

In the embodiment, the first SOC level may be the upper limit SOCₘₐₓ of the allowable SOC of the first battery, and the second SOC level may be the lower limit of the normal range SOCₙₗ of the SOC of the first battery.

In some implementations, the turning on the first sub path to provide power from the PV module to the first battery further includes:
in a case that the output power of the PV module is equal to the input power of the freezer compressor and the SOC of the first battery is less than the first SOC level, adding the external power adapter or the engine generator, whichever available, to the first sub path, to provide additional power to the first battery.
the second path further includes a second sub path to the first battery, and the method further includes:
in a case that a state of charge (SOC) of the first battery is less than a first SOC level and equal to or more than a second SOC level, turning on the second sub path to provide power from the PV module to the first battery;
in a case that the SOC of the first battery is less than the second SOC level, adding the external power adapter, to the second sub path, to provide additional power to the first battery; and
in a case that the SOC of the first battery is more than the first SOC level, turning off the second sub path and adding the PV module to the second path to provide additional power to the freezer compressor.

In some implementations, the external power adapter is an external energy storage source and the second path further includes a second sub path to the first battery, and wherein switching to the second path from the external power adapter to the freezer compressor includes:
in a case that a power of the external energy storage source is greater than the input power of the freezer compressor, turning on the second sub path to provide additional power to the first battery from the external energy storage source; and
in a case that the power of the energy storage source is smaller than the input power of the freezer compressor, turning on the second sub path to provide additional power to the freezer compressor from the first battery.

In some implementations, in a case that the input power of the freezer compressor is zero, the second sub path is turned on and the method further includes:
charging the first battery with the external energy storage source through the second sub path; or
charging the external energy storage source with the first battery through the second sub path when the external energy storage source requires to be charged and a SOC of the first battery is greater than a second SOC level.

In some implementations, the method further includes: in a case that the external power adapter has no external power input and an output power of the engine generator is greater than the input power of the freezer compressor, connecting the engine generator to the second path to replace the external power adapter.

In some implementations, the third path further includes a third sub path to the engine generator, and the method further includes:
in a case that a state of charge (SOC) of the first battery is less than a second SOC level, turning on the third sub path to provide additional power to the third path by the engine generator.

In some implementations, the method further includes: in a case that the additional power provided by the engine generator is greater than a difference between the input power of the freezer compressor and the output power of the PV module, stopping an output of the first battery and charging the first battery with the additional power provided by the engine generator in addition to providing the additional power to the freezer compressor.

In some implementations, the method further includes: in a case that the additional power provided by the engine generator is less than a difference between the input power of the freezer compressor and the output power of the PV module, warning that the first battery needs to be charged when the SOC of the first batter is draped to a third SOC level.

In the embodiment, the third SOC level may be the lower limit SOCₘᵢₙ of the allowable SOC of the first battery.

In some implementations, the solar freezer truck further includes a second battery connected to the engine generator, and wherein the additional power provided by the engine generator is provided to the third sub path through the second battery.

Hereinafter, the implementation of the present disclosure is discussed in further detail with reference to the embodiment shown in FIG. 1A.

In the embodiment shown in FIG. 1A, the freezer compressor 130 is an AC compressor, and solar freezer truck 100 further includes a first charger 115, a second charger 155, a third charger 145, a DC-AC inverter 170, a second battery 141, an engine 142, a first switch S1, a second switch S2, a third switch S3, a fourth switch S4, a fifth switch S5, a sixth switch S6 and a seventh switch S7.

The PV module 110 can convert the solar energy to the electric energy, comprises a number of photo-voltaic (PV) panels that are mounted on the roof of the solar truck 100 and may be connected in series and parallel and coupled with solar cell equalizers.

The first charger 115 is a DC charger, is energized by the DC power to output the DC power, is to regulate the output power of the PV module, implement the maximum power point tracking (MPPT) control of the PV module and output the DC energy to the first battery via turning on the first switch S1 and the DC-AC inverter, and is controlled by the energy management unit.

The first battery 120 is a rechargeable battery, such as a Li-ion battery, can release the DC energy to the DC-AC inverter via turning on the first switch S1 and store the DC energy output by the first charger 115 via turning on the first switch, the second charger 155 via turning on the third switch and the third charger 145 via turning on the fifth switch, may be charged by the PV module 110 via the first charger 115 and turning on the first switch, by the AC supply 150 via the second charger 155 and turning on the third and fourth switches and by the second battery 141 via the third charger 145 and turning on the fifth and sixth switches, and may output the electric energy to the AC compressor system 130 via the DC-AC inverter 170 and turning on the first and second switches. The state of charge (SOC) of the first battery is bounded in [SOCₘᵢₙ, SOCₘₐₓ], such as [0.2, 1.0], and the first battery has a high operating efficiency and long service lifetime if the SOC of the first battery is changed in the normal range [SOCₙₗ, SOCₙᵤ], such as [0.55, 0.85].

The DC-AC inverter 170 can convert the DC power to the AC power and is controlled by the energy management unit. The input of the DC-AC inverter is the DC power, and the output of the DC-AC inverter is the AC power, such as the three-phase AC 50 Hz 380 V.

The AC compressor system 130 requires to be energized by the AC power, such as the three-phase AC 50 Hz 380 V, which controls the refrigeration temperature of the solar freezer truck, can be energized by the DC-AC inverter via turning on the second switch, by the AC supply via turning on the seventh switch, and the input power of the AC compressor system depends on the controlled temperature.

The second charger 155 is an AC charger, is energized by the AC power, and is controlled by the energy management unit, can charge the first battery 120 via turning on the third and fourth switches and output the DC energy to the DC-AC inverter via turning on the first, third and fourth switches.

The AC supply 150 is an offboard AC supply and provides the AC power to the energy management system, such as the three-phase AC 50 Hz 380 V.

The third charger 145 is a DC charger, is energized by the DC power, is controlled by the energy management unit, and can charge the first battery via turning on the fifth and sixth switches and outputting the DC energy to the DC-AC inverter via turning on the first, fifth and sixth switches.

The second battery 141 is a rechargeable onboard battery, such as a 24 V lead-acid battery, which can be charged by the generator system 140 to maintain the voltage of the second battery at the required level (such as 24 V DC) when the solar freezer truck is being driven, and may output the DC energy to the third charger 145 via turning on the sixth switch.

The generator system 140 is an onboard generator system, is driven by the engine 142, such as a diesel engine, and is to output the DC energy to the second battery.

The switches 1-7 are the controllable components that are controlled by the energy management unit, such as relays, each switch has two contacts and a control input, the two contacts of the switch are open if a switch is turned off by the energy management unit, and the two contacts of the switch are close if a switch is turned on by the energy management unit.

The energy management unit 160 is an electric circuit based on a microcontroller, can receive the measured power from the first charger and AC compressor system and the SOC from the first battery, execute the energy management strategy and output the control signals to the first charger, the DC-AC inverter, the second charger, the third charger and the seven switches.

Moreover, FIG. 1B illustrates is a schematic diagram of a solar freezer truck according to an embodiment of the present disclosure, in which the solar freezer truck includes an energy management system similar to that shown in FIG. 1A, differing in that the energy management system of the present embodiment further includes an external energy storage source 180, a fourth charger 185, an eighth switch S8 and a ninth switch S9.

The fourth charger 185 is a bi-directional DC-DC converter, controlled by the energy management unit 160 and may charge the first battery 120 from the external energy storage source 180, such as the first battery of another freezer truck, or charge the external energy storage source 180 from the first battery, via turning on the eighth switch S8 and ninth switch S9.

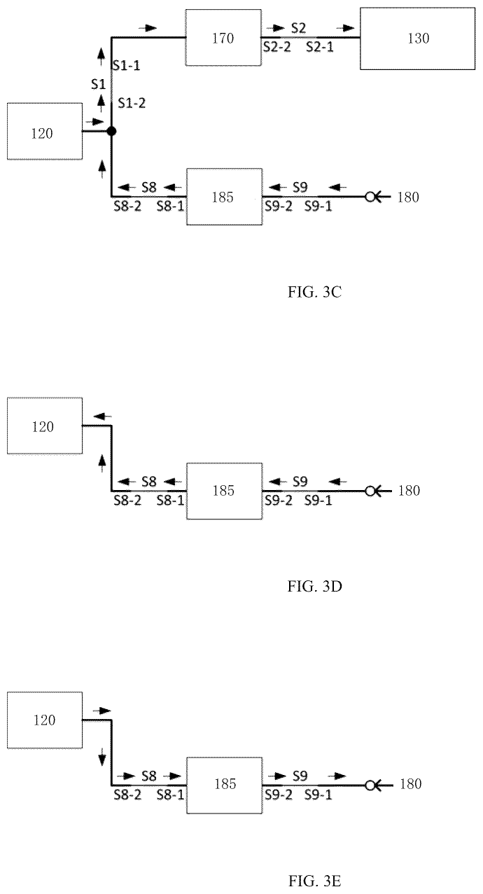

Hereinafter, further details of the energy management modes in particular cases are discussed with reference to the schematic diagrams shown in FIG. 3A to FIG. 19, based on typical operating sates of the solar freezer truck.

Scenario 1: The solar freezer truck is at a standstill for a long time, the AC supply 150 may provide the AC energy to the energy management system, and the generator system 140 may not provide the DC energy to the second battery 141.

If the PV module 110 cannot output the electric power, then, as shown in FIG. 3A, if SOC is less than SOCₘₐₓ, then the third, fourth and seventh switches are turned on by the energy management unit 160, the remaining switches are turned off by the energy management unit 160, and the AC supply 150 outputs the energy to the first battery 120 via the second charger 155, fourth and third switches and the AC compressor system 130 via the seventh switch. In the drawings, the arrow represents the power flow, Sk-1 represents the first contact of the k-th switch, and Sk-2 represents the second contact of the k-the switch (k=1, 2, . . . , 7).

In another embodiment, as shown in FIG. 3B, the external energy storage source 180 may be used to provide external power to the solar freezer truck in the case that the AC supply 150 is not available. For example, when the AC supply 150 is not available and the external energy storage source 180 is available, if the power of the external energy storage source 180 is more than the input power of the AC compressor system 130, then the first, second, eighth and ninth switches are turned on, the remain switches are turned off, the external energy storage source 180 outputs the energy to the first battery 120 via the fourth charger 185, eighth and ninth switches, and the AC compressor system 130 via the fourth charger 185, the DC-AC inverter 170, eighth, ninth, first and second switches, as shown in FIG. 3B.

In this embodiment, if the power of the external energy storage source 180 is less than the input power of the AC compressor system 130, then the first, second, eighth and ninth switches are turned on, the remain switches are turned off, the first battery 120 outputs the energy to the AC compressor system 130 via the DC-AC inverter 170, first and second switches, and the external energy storage source 180 outputs the energy the AC compressor system 130 via the fourth charger 185, the DC-AC inverter 170, eighth, ninth, first and second switches, as shown in FIG. 3C.

Furthermore, in this embodiment, if the input power of the AC compressor system 130 is zero, the fourth charger 185 may be configured to charge the first battery 120 with the external energy storage source 180, or charge the external energy storage source 180 with the first battery 120.

In particular, as shown in FIG. 3D, the input power of the AC compressor system 130 is zero, then the eighth and ninth switches are turned on, the remain switches are turned off, the external energy storage source 180 outputs the energy to the first battery 120 via the fourth charger 185, eighth and ninth switches.

Otherwise, as shown in FIG. 3E, the input power of the AC compressor system 130 is zero, and the SOC of the first battery 120 is more than SOCₘᵢₙ and the external energy storage source 180 requires to be charged, then the eighth and ninth switches are turned on, the remain switches are turned off, and the first battery 120 outputs the energy to the external energy storage source 180 via the fourth charger 185, eighth and ninth switches.

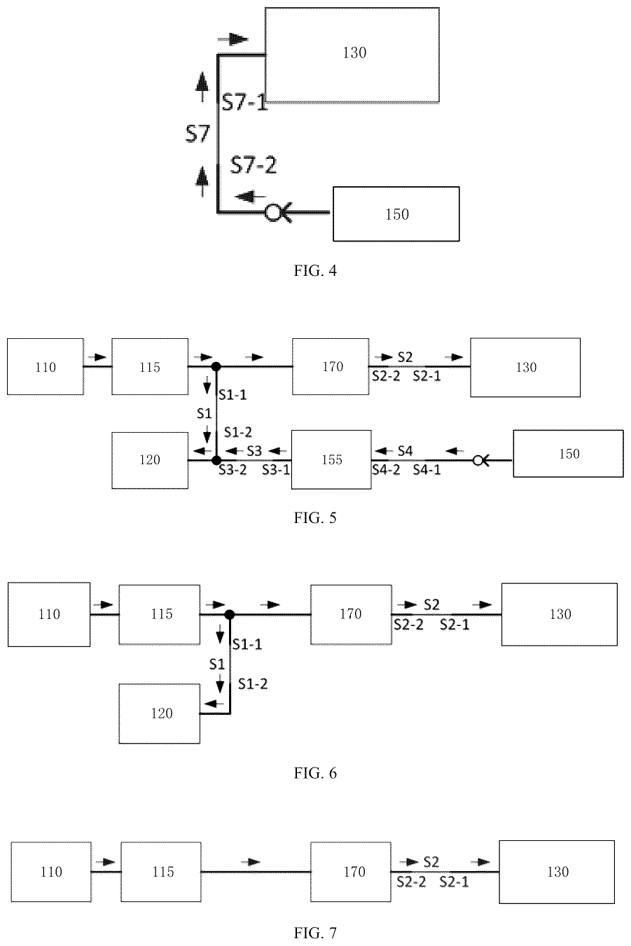

Furthermore, in the case where the AC power supply is available, and the first battery does not need charging, the seven switch is turned on by the energy management unit 160, the remaining switches are turned off by the energy management unit 160, and the AC supply 150 outputs the energy to the AC compressor system 130 via the seventh switch, as shown in FIG. 4.

Also, if the PV module 110 can output the electric power more than the input power of the AC compressor system 130, then, if SOC is less than SOCₙₗ, then the first, second, third and fourth switches are turned on by the energy management unit 160, the remaining switches are turned off by the energy management unit 160, the PV module 110 outputs the energy to the AC compressor system 130 via the first charger 115, DC-AC inverter 170 and second switch and the first battery 120 via the first charger 115 and first switch, and the AC supply 150 outputs the energy to the first battery 120 via the second charger, fourth and third switches, as shown in FIG. 5.

Otherwise, if the SOC is equal to or more than SOCₙₗ and less than SOCₘₐₓ, then the first and second switches are turned on by the energy management unit 160, the remaining switches are turned off by the energy management unit 160, and the PV module 110 outputs the energy to the AC compressor system 130 via the first charger, DC-AC inverter 170 and second switch and the first battery via the first charger 115 and first switch, as shown in FIG. 6.

Otherwise, if the SOC is equal to or more than SOCₘₐₓ, the second switch is turned on by the energy management unit 160, the remaining switches are turned off by the energy management unit 160, and the PV module 110 outputs the energy to the AC compressor system 130 via the first charger, DC-AC inverter 170 and second switch, as shown in FIG. 7.

In this embodiment, if the output power of the PV module 110 is less than the input power of the AC compressor system 130, then, if the SOC is less than SOCₙₗ, then the first, third, fourth and seventh switches are turned on by the energy management unit 160, the remaining switches are turned off by the energy management unit 160, the PV module 110 outputs the energy to the first battery 120 via the first charger 115, first switch, and the AC supply 150 outputs the energy to the AC compressor system 130 via the seventh switch and the first battery 120 via the second charger 155, fourth and third switches, as shown in FIG. 8.

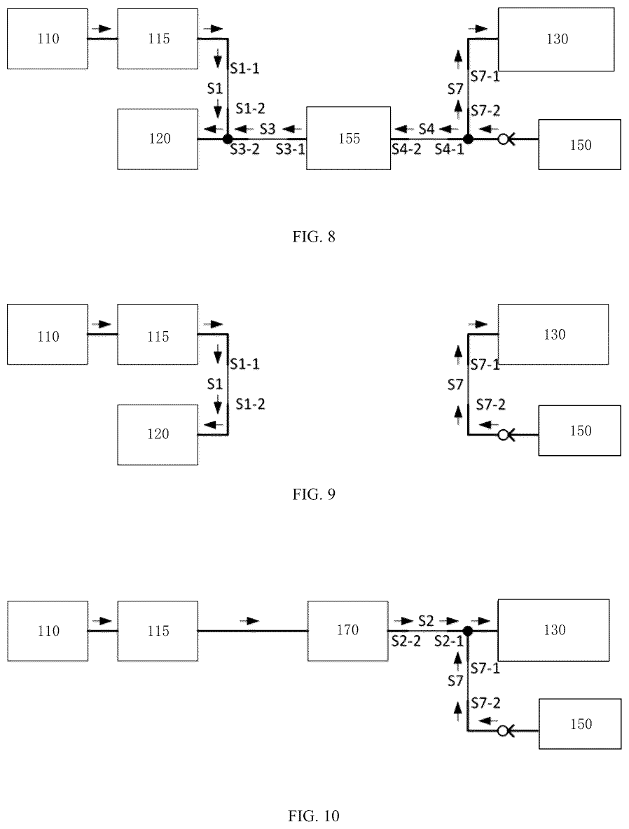

Otherwise, if the SOC is equal to or more than SOCₙₗ and less than SOCₘₐₓ, then the first and seventh switches are turned on by the energy management unit 160, the remaining switches are turned off by the energy management unit 160, the PV module 110 outputs the energy to the first battery 120 via the first charger 115 and first switch, and the AC supply 150 outputs the energy to the AC compressor system 130 via the seventh switch, as shown in FIG. 9.

Otherwise, if the SOC is equal to or more than SOCₘₐₓ, the second and seventh switches are turned on by the energy management unit 160, the remaining switches are turned off by the energy management unit 160, the PV module 110 outputs the energy to the AC compressor system 130 via the first charger 115, DC-AC inverter 170 and second switch, and the AC supply 150 outputs the energy to the AC compressor system 130 via the seventh switch, as shown in FIG. 10.

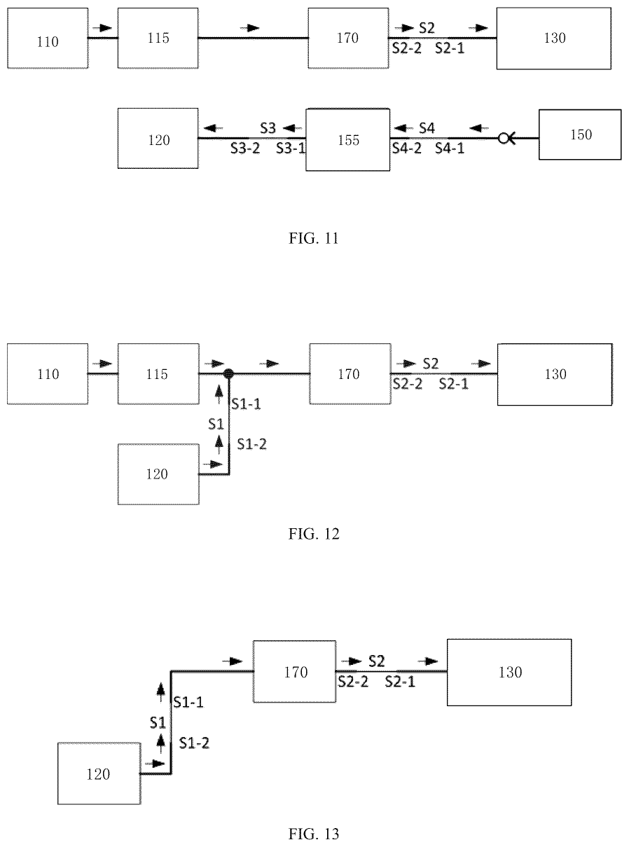

In this embodiment, if the output power of the PV module 110 is equal to the input power of the AC compressor system 130, the operation of the system may be similar to those discussed with reference to FIG. 5 and FIG. 7, with the difference that all the power of the PV module 110 is provided to the AC compressor system 130. Therefore, the first battery 120 is charged by the AC supply 150 via the fourth switch, the second charger 155, and the third switch, if the SOC is less than SOCₘₐₓ. Also, in this case, no power is provided from the PV module 110 to the first battery 120, as shown in FIG. 11.

Scenario 2: The solar freezer truck 100 is at standstill for a short time, the AC supply 150 may not provide the AC energy to the energy management system, and the generator system 140 may not provide the DC energy to the second battery 141.

In this case, if the PV module 100 can output power greater than the input power of the AC compressor system 130, the AC compressor system 130 is driven all by the power from the PV module 100, and the spare power of the PV module 100 may be further supplied to the first battery 120 if the SOC thereof is less than SOCₘₐₓ, similar to the embodiments discussed with reference to FIG. 6 and FIG. 7, which will not be repeated herein.

Otherwise, if the output power of the PV module 110 is less than the input power of the AC compressor system 130, then the first and second switches are turned on by the energy management unit 160, the remaining switches are turned off by the energy management unit 160, the PV module 110 outputs the energy to the AC compressor system 130 via the first charger 115, DC-AC inverter 170 and second switch, and the first battery 120 outputs the energy to the AC compressor system 130 via the DC-AC inverter 170, first and second switches, as shown in FIG. 12. Further, if the output power of the PV module 100 drops to zero, the AC compressor system 130 is driven all by the power from the first battery 115, i.e., in this case, the first charger 115 can be considered as been cut off from the circuit, as shown in FIG. 13.

Scenario 3: The solar freezer truck 100 is being driven, the AC supply 150 may not provide the AC energy to the energy management system, and the generator system 140 can provide the DC energy to the second battery 141.

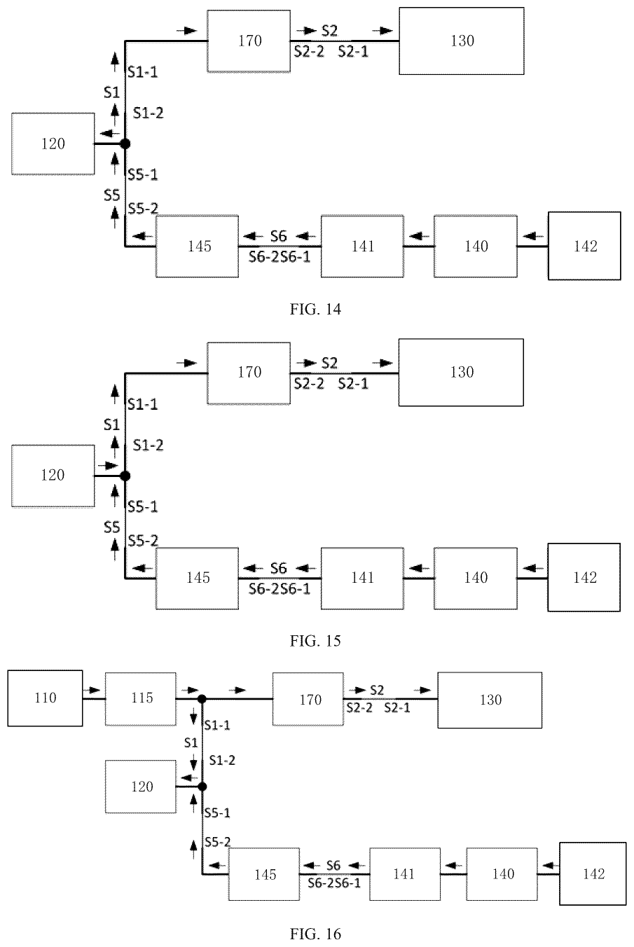

In this embodiment, in the case that PV module 110 cannot output the electric power, then, if the rated power of the third charger 145 is more than the input power of the AC compressor system 130, then, if SOC is less than SOCₙₗ, then the first, second, fifth and sixth switches are turned on by the energy management unit 160, the remaining switches are turned off by the energy management unit 160, and the second battery 141 outputs the energy to the first battery 120 via the third charger 145, fifth and sixth switches and the AC compressor system 130 via the third charger 145, DC-AC inverter 170, first, second, fifth and sixth switches, as shown in FIG. 14.

Otherwise, if the rated power of the third charger 145 is equal to or less than the input power of the AC compressor system, if SOC is less than SOCₙₗ, then the first, second, fifth and sixth switches are turned on by the energy management unit 160, the remaining switches are turned off by the energy management unit 160, the first battery 120 outputs the energy to the AC compressor system 130 via the DC-AC inverter 170, first and second switches, and the second battery 141 outputs the energy to the AC compressor system 130 via the third charger 145, DC-AC inverter 170, first, second, fifth and sixth switches, as shown in FIG. 15, and the warning that the first battery 120 needs to be charged is sent if SOC is less than SOCₘᵢₙ.

In this embodiment, if the SOC of the first battery 120 is equal to or more than SOCₙₗ, the AC compressor system 130 is driven all by the power from the first battery 120, similar to the embodiment shown in FIG. 13, which will not be repeated herein.

In this embodiment, in the case that the output power of the PV module 110 is equal to or greater than the input power of the AC compressor system 130, the embodiment is similar to the embodiment described with reference to FIGS. 4 to 6, differing in that in the case SOC is less than SOCₙₗ, the generator system 140 is used instead of the AC supply 150. For example, as shown in FIG. 16, the first, second, fifth and sixth switches are turned on by the energy management unit 160, the remaining switches are turned off by the energy management unit 160, the PV module 110 outputs the energy to the AC compressor system via the first charger 115, DC-AC inverter 170 and second switch and the first battery 120 via the first charger 115 and first switch, and the second battery 141 outputs the energy to the first battery 120 via the third charger 145, sixth and fifth switches.

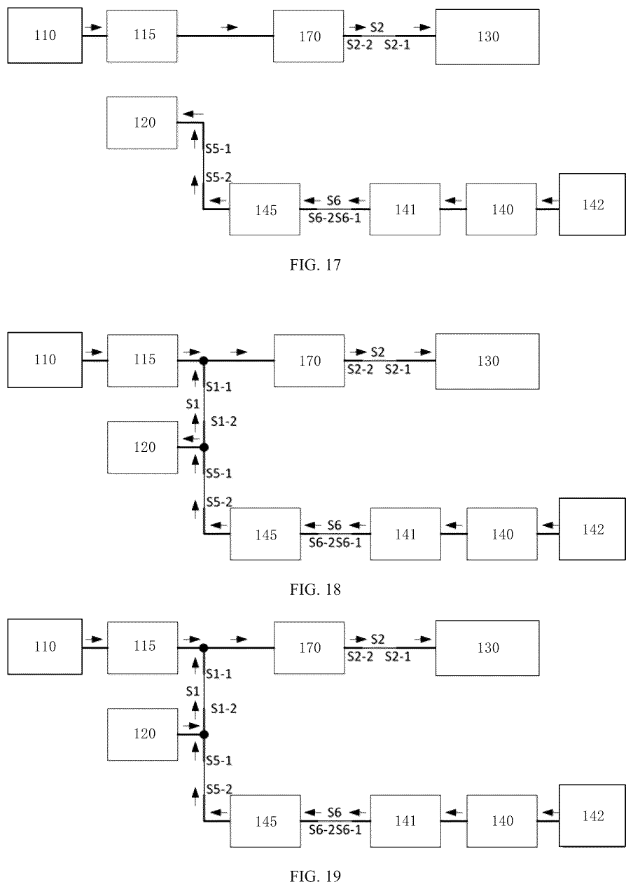

In this embodiment, if the output power of the PV module 110 is equal to the input power of the AC compressor system 130, the operation of the system may be similar to that discussed in FIG. 11, differing in that the generator system 140 is used instead of the AC supply 150, as shown in FIG. 17, which will not be repeated herein.

In this embodiment, in the case that the output power of the PV module 110 is less than the input power of the AC compressor system 130, then, if SOC is less than SOCₙₗ, then, in the case that the rated power of the third charger 145 is more than the difference between the input power of the AC compressor system 130 and output power of the PV module 110, then the first, second, fifth and sixth switches are turned on by the energy management unit 160, the remaining switches are turned off by the energy management unit 160, the PV module 110 outputs the energy to the AC compressor system 130 via the first charger 115, DC-AC inverter 170 and second switch, and the second battery 141 outputs the energy to the AC compressor system 130 via the third charger 145, DC-AC inverter 170, sixth, fifth, first and second switches and the first battery 120 via the third charger 145, sixth and fifth switches, as shown in FIG. 18.

Otherwise, if the rated power of the third charger 145 is equal to or less than the difference between the input power of the AC compressor system 130 and output power of the PV module 110, the first, second, fifth and sixth switches are turned on by the energy management unit 160, the remain switches are turned off by the energy management unit 160, the PV module 110 outputs the energy to the AC compressor system 130 via the first charger 115, DC-AC inverter 170 and second switch, the first battery 120 outputs the energy to the AC compressor system 130 via the DC-AC inverter 170, first and second switches, the second battery 141 outputs the energy to the AC compressor system 130 via the third charger 145, DC-AC inverter 170, sixth, fifth, first and second switches, as shown in FIG. 19, and the warning that the first battery 120 needs to be charged is sent if SOC is less than SOCₘᵢₙ.

In this embodiment, if the SOC is equal to or more than SOCₙₗ, the AC compressor system 130 is driven all by the power of the PV module 110 and the first battery 120, similar to the embodiment shown in FIG. 12, which will not be repeated therein.

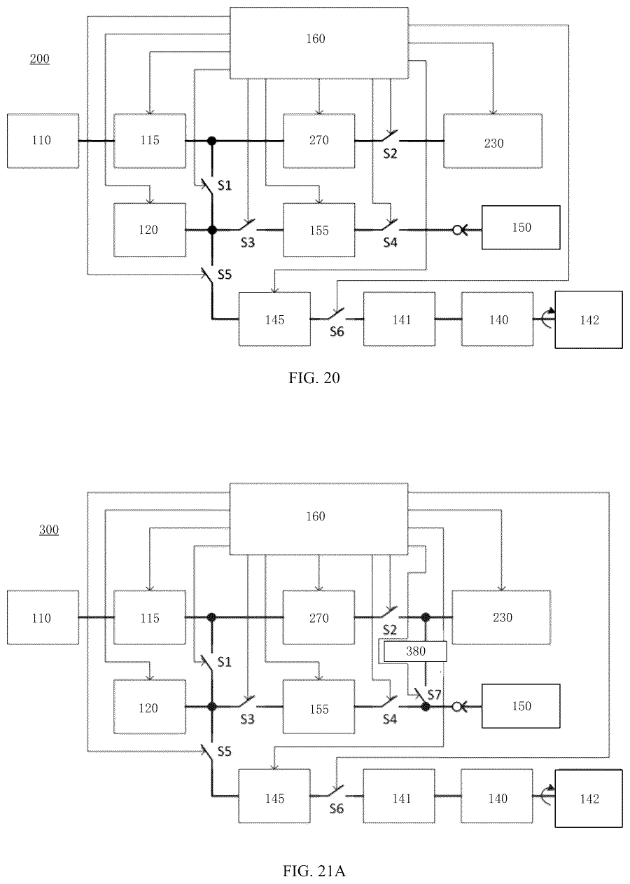

In the embodiments discussed above, the AC compressor system is disclosed as an example of freezer compressor 130, while the disclosure is not limited thereto. Other freezer compressors driven by electric power is applicable to the present disclosure. For example, as shown in FIG. 20, the freezer truck 200 includes similar elements as those of the freezer truck 100 discussed in the above embodiments, differing in that the freezer compressor includes a DC compressor system 230, and correspondingly a DC-DC converter 270 is included instead of the DC-AC converter 170, and the power from the AC supply 150 is provided to the DC compressor system 230 through the second charger 155, the DC-DC converter 270, and the first to fourth switches. Other elements are similar to those discussed in the above embodiments, and repeated description thereof will be omitted.

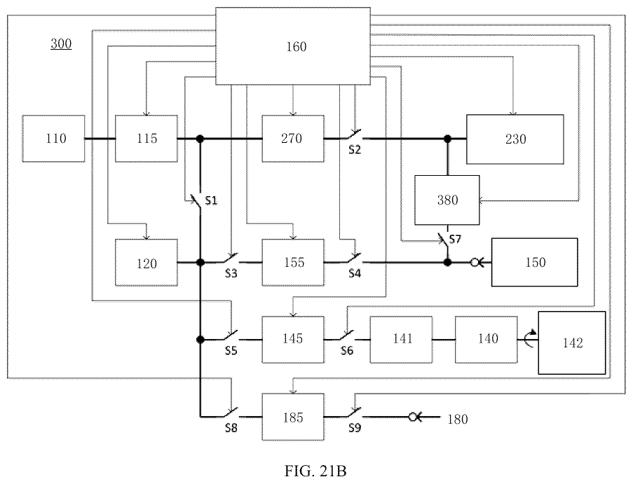

In another embodiment, as shown in FIG. 21A, the freezer truck 300 further includes a seven switch S7 and a rectifier 380 connected between the AC supply 150 and the DC compressor system 230, the AC power provided by the AC supply 150 is rectified by the rectifier 380 into DC power and is then supplied to the DC compressor system 230. Other elements are similar to those discussed in the above embodiments, and repeated description thereof will be omitted.

Furthermore, similar to the embodiment shown in FIG. 1A and FIG. 1B, the energy management system for freezer truck of the embodiments shown in FIG. 21A may further include the external energy storage source 180, the fourth charger 185, the eighth switch S8 and the ninth switch S9, as shown in FIG. 21B. Details of these embodiments may refer to the description with reference to FIG. 1B, which will not be repeated herein.

The energy management unit 160 in the embodiment above may be implemented by a circuit configured to perform the functions of the energy management unit 160, such as a logical circuit configured to execute computer readable instructions to perform the corresponding functions. The circuit may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components or any combination thereof. It may implement or execute various exemplary logic blocks, modules and circuits described in conjunction with the disclosure of the present invention. The processor may also be a combination that implements computing functions, such as a combination of one or more microprocessors, a combination of a DSP and a microprocessor, or the like.

In the several embodiments provided in the embodiments of the present disclosure, it should be understood that the disclosed device can also be implemented in other ways. The device embodiments described above are only exemplary.

It should be noted that, in this disclosure, the terms “first”, “second”, etc. in the specification and claims of this application and the above-mentioned drawings are used to distinguish similar objects, and are not necessarily used to describe a specific order or sequence. The terms “comprise”, “include” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the sentence “comprises a . . . ” does not exclude the presence of other identical elements in the process, method, article or device including the element.

Although the embodiments disclosed in the present disclosure are as above, the contents described are only embodiments adopted for facilitating the understanding of the present disclosure and are not intended to limit the present disclosure. Any of those skilled in the art to which the present disclosure belongs can make any modifications and changes in the form and details of the implementation without departing from the spirit and scope disclosed in the present disclosure, but the patent protection scope of the present disclosure shall still be subject to the scope defined in the attached claims.

What is claimed is:

1. An energy management method for solar freezer truck comprising a photo-voltaic (PV) module, a first battery, a freezer compressor, an engine generator, and an external power adapter connected by an energy management unit, the method comprising:
obtaining an output power of the PV module; and
switching, by the energy management unit, power paths to the freezer compressor according to the output power of the PV module.

2. The method according to claim 1, wherein the solar freezer truck further comprises a first charger configured to converting the output power of the PV module to a power on the power paths, and wherein the first charger is configured to always maximize the output power of the PV module if the PV module can output power.

3. The method according to claim 2, wherein the switching, by the energy management unit of the solar freezer truck, power paths to the freezer compressor according to the output power of the PV module comprises:
in a case that the output power of the PV module is equal to or greater than an input power of the freezer compressor, switching to a first path from the PV module to the freezer compressor;
in a case that the output power of the PV module is smaller than the input power of the freezer compressor and the external power adapter has an external power input, switching to a second path from the external power adapter to the freezer compressor; and
in a case that the output power of the PV module is smaller than the input power of the freezer compressor and the external power adapter has no external power input, switching to a third path from the PV module and the first battery to the freezer compressor.

4. The method according to claim 3, wherein the first path further comprises a first sub path to the first battery, and the method further comprises:
in a case that a state of charge (SOC) of the first battery is less than a first SOC level and equal to or more than a second SOC level, turning on the first sub path to provide power from the PV module to the first battery;
in a case that the SOC of the first battery is less than the second SOC level, adding the external power adapter or the engine generator, whichever available, to the first sub path, to provide additional power to the first battery; and
in a case that the SOC of the first battery is more than the first SOC level, turning off the first sub path and supplying all power of the PV module to the freezer compressor.

5. The method according to claim 4, wherein the turning on the first sub path to provide power from the PV module to the first battery further comprises:
in a case that the output power of the PV module is equal to the input power of the freezer compressor and the SOC of the first battery is less than the first SOC level, adding the external power adapter or the engine generator, whichever available, to the first sub path, to provide additional power to the first battery.

6. The method according to claim 3, wherein the second path further comprises a second sub path to the first battery, and the method further comprises:
in a case that a state of charge (SOC) of the first battery is less than a first SOC level and equal to or more than a second SOC level, turning on the second sub path to provide power from the PV module to the first battery;
in a case that the SOC of the first battery is less than the second SOC level, adding the external power adapter, to the second sub path, to provide additional power to the first battery; and
in a case that the SOC of the first battery is more than the first SOC level, turning off the second sub path and adding the PV module to the second path to provide additional power to the freezer compressor.

7. The method according to claim 3, wherein the external power adapter is an external energy storage source and the second path further comprises a second sub path to the first battery, and wherein switching to the second path from the external power adapter to the freezer compressor comprises:
in a case that a power of the external energy storage source is greater than the input power of the freezer compressor, turning on the second sub path to provide additional power to the first battery from the external energy storage source; and
in a case that the power of the energy storage source is smaller than the input power of the freezer compressor, turning on the second sub path to provide additional power to the freezer compressor from the first battery.

8. The method according to claim 7, wherein in a case that the input power of the freezer compressor is zero, the second sub path is turned on and the method further comprises:
charging the first battery with the external energy storage source through the second sub path; or
charging the external energy storage source with the first battery through the second sub path when the external energy storage source requires to be charged and a SOC of the first battery is greater than a second SOC level.

9. The method according to claim 3, wherein the method further comprises: in a case that the external power adapter has no external power input and an output power of the engine generator is greater than the input power of the freezer compressor, connecting the engine generator to the second path to replace the external power adapter.

10. The method according to claim 3, wherein the third path further comprises a third sub path to the engine generator, and the method further comprises:
in a case that a state of charge (SOC) of the first battery is less than a second SOC level, turning on the third sub path to provide additional power to the third path by the engine generator.

11. The method according to claim 10, wherein the method further comprises: in a case that the additional power provided by the engine generator is greater than a difference between the input power of the freezer compressor and the output power of the PV module, stopping an output of the first battery and charging the first battery with the additional power provided by the engine generator in addition to providing the additional power to the freezer compressor.

12. The method according to claim 10, wherein the method further comprises: in a case that the additional power provided by the engine generator is less than a difference between the input power of the freezer compressor and the output power of the PV module, adding the first battery to provide additional power to the freezer compressor, warning that the first battery needs to be charged when the SOC of the first batter is draped to a third SOC level.

13. The method according to claim 10, wherein the solar freezer truck further comprises a second battery connected to the engine generator, and wherein the additional power provided by the engine generator is provided to the third sub path through the second battery.

14. A solar freezer truck, comprising a photo-voltaic (PV) module, a first battery, a freezer compressor, an engine generator, and an external power adapter connected by an energy management unit, wherein the energy management unit comprises a circuit configured to:
switch power paths to the freezer compressor according to the output power of the PV module.

15. The solar freezer truck according to claim 14, further comprising a first charger configured to converting the output power of the PV module to a power on the power paths, and wherein the first charger is configured to always maximize the output power of the PV module if the PV module can output power.

16. The solar freezer truck according to claim 15, wherein the circuit is further configured to:
in a case that the output power of the PV module is equal to or greater than an input power of the freezer compressor, switch to a first path from the PV module to the freezer compressor;
in a case that the output power of the PV module is smaller than the input power of the freezer compressor and the external power adapter has an external power input, switch to a second path from the external power adapter to the freezer compressor; and
in a case that the output power of the PV module is smaller than the input power of the freezer compressor and the external power adapter has no external power input, switch to a third path from the PV module and the first battery to the freezer compressor.

17. The solar freezer truck according to claim 16, wherein the first path further comprises a first sub path to the first battery, and the circuit is further configured to:
in a case that a state of charge (SOC) of the first battery is less than a first SOC level and equal to or more than a second SOC level, turn on the first sub path to provide power from the PV module to the first battery;
in a case that the SOC of the first battery is less than the second SOC level, add the external power adapter or the engine generator, whichever available, to the first sub path, to provide additional power to the first battery; and
in a case that the SOC of the first battery is more than the first SOC level, turn off the first sub path and supply all power of the PV module to the freezer compressor.

18. The solar freezer truck according to claim 17, wherein the circuit is further configured to:
in a case that the output power of the PV module is equal to the input power of the freezer compressor and the SOC of the first battery is less than the first SOC level, add the external power adapter or the engine generator, whichever available, to the first sub path, to provide additional power to the first battery.

19. The solar freezer truck according to claim 16, wherein the second path further in comprises a second sub path to the first battery, and the circuit is further configured to:
in a case that a state of charge (SOC) of the first battery is less than a first SOC level and equal to or more than a second SOC level, turn on the second sub path to provide power from the PV module to the first battery;
in a case that the SOC of the first battery is less than the second SOC level, add the external power adapter, to the second sub path, to provide additional power to the first battery; and
in a case that the SOC of the first battery is more than the first SOC level, turn off the second sub path and adding the PV module to the second path to provide additional power to the freezer compressor.

20. The solar freezer truck according to claim 16, wherein the external power adapter is an external energy storage source and the second path further comprises a second sub path to the first battery, and the circuit is further configured to:
in a case that a power of the external energy storage source is greater than the input power of the freezer compressor, turn on the second sub path to provide additional power to the first battery from the external energy storage source; and
in a case that the power of the energy storage source is smaller than the input power of the freezer compressor, turn on the second sub path to provide additional power to the freezer compressor from the first battery.
